(19) United States
(12) Patent Application Publication
(10) Pub. No.: US 2024/0101871 A1
(43) Pub. Date: Mar. 28, 2024

(54) CURABLE PRESSURE-SENSITIVE ADHESIVE HAVING IMPROVED ADHESIVE PROPERTIES

(71) Applicant: tesa SE, Norderstedt (DE)

(72) Inventors: Christian Schuh, Hamburg (DE); Sven Heidsieck, Hamburg (DE); Oleg Brinster, Hamburg (DE)

(73) Assignee: tesa SE, Norderstedt (DE)

(21) Appl. No.: 18/374,502

(22) Filed: Sep. 28, 2023

(30) Foreign Application Priority Data
Sep. 28, 2022 (DE) 10 2022 124 904.2

(51) Int. Cl. C09J 7/38; C08J 7/18; C09J 163/00

(52) U.S. Cl. CPC C09J 7/381; C08J 7/18; C09J 163/00; C08J 2363/00

(57) ABSTRACT

The invention relates to a curable pressure-sensitive adhesive, comprising, based on the total mass of the curable pressure-sensitive adhesive: a) one or more film-forming (co)polymers in a combined mass fraction in the range from 20% to 60%, b) one or more polymerizable epoxide compounds in a combined mass fraction in the range from 20% to 60%, the epoxide compounds being selected from the group consisting of monomeric and oligomeric epoxide compounds, c) one or more cationic photoinitiators in a combined mass fraction in the range from 0.5% to 7%, and d) one or more epoxy-modified nitrile rubbers in a combined mass fraction in the range from 3% to 30%.

The invention relates to a curable pressure-sensitive adhesive and to a pressure-sensitive adhesive tape comprising such a curable pressure-sensitive adhesive, and also to a use of such curable pressure-sensitive adhesives and pressure-sensitive adhesive tapes for bonding two or more components.

The joining of separate elements is one of the central processes in manufacturing. Besides other methods, such as welding and soldering, for example, an important significance is nowadays accorded in particular to adhesive bonding, i.e. to joining using an adhesive. One alternative to the use of formless adhesives which are applied from a tube, for example, are so-called adhesive tapes. Known from everyday life in particular are pressure-sensitive adhesive tapes, where a pressure-sensitive adhesive provides the bonding effect, which under typical ambient conditions is durably tacky and also adhesive. Such pressure-sensitive adhesive tapes may be applied by pressure to a substrate and remain adhering there, but later on can be removed again more or less without residue.

Particularly for use in industrial manufacturing, however, there is also another type of adhesive tapes of great significance. In these adhesive tapes, which are sometimes also referred to as reactive adhesive tapes, a curable adhesive is employed. In the state intended for application, curable adhesives of these kinds have not yet attained their maximum crosslinking, and can be cured by external influences, with initiation of the polymerization in the curable adhesive and a consequent increase in the crosslinking. This is accompanied by changes in the mechanical properties of the now cured adhesive, with increases in particular in the viscosity, the surface hardness and the strength.

Curable adhesives are known in the prior art and from a chemical standpoint may have very different compositions. Common to these curable adhesives is the possibility of initiating the cross-linking reaction by means of external influencing factors, such as by supply of energy, for example, in particular through thermal curing, plasma curing or radiation curing, and/or by contact with a substance that promotes the polymerization, as is the case, for example, with moisture-curing adhesives. Illustrative adhesives are disclosed for example in DE 102015222028 A1, EP 3091059 A1, EP 3126402 B1,EP 2768919 B1, DE 102018203894 A1, WO 2017174303 A1, JP 2021166289 A and US 4661542 A.

From performance standpoints, particular preference is given in particular to reactive adhesives which combine good curability with pressure-sensitive adhesive properties. Such reactive pressure-sensitive adhesives and pressure-sensitive adhesive tapes based on them may be applied easily and reliably before curing, and corrections to the positioning may be possible, before the reactive pressure-sensitive adhesive is cured. The pressure-sensitive adhesiveness of such reactive pressure-sensitive adhesives also allows easy preliminary fixing of elements intended for bonding.

For the skilled person, when designing performance-capable reactive pressure-sensitive adhesives, it is in practice generally not a trivial matter at the same time to achieve advantageous pressure-sensitive adhesiveness with favourable cohesion of the adhesive and a high peel adhesion, and at the same time to ensure excellent bonding strength in the cured state and also advantageous curing kinetics; occasionally, indeed, this is perceived to be a conflict of objectives.

In the field of adhesive technology, there is continued interest, against this background, in improving reactive pressure-sensitive adhesives such that they exhibit improved pressure-sensitive adhesiveness with high peel adhesions and also an improved bonding strength after curing.

The primary object of the present invention was to eliminate or at least attenuate the disadvantages of the prior art.

A particular object of the present invention was to specify a curable pressure-sensitive adhesive which not only possesses advantageous pressure-sensitive adhesiveness and an excellent peel adhesion in the uncured state, but also exhibits an advantageous bonding strength in the cured state as well.

An object of the present invention in this context was that the curable pressure-sensitive adhesive to be specified ought to be able to be cured reliably and with favourable curing kinetics by radiation curing, in particular even when using typical UV-LEDs as the radiation source.

A further object of the present invention was that the curable adhesive to be specified ought to exhibit the greatest possible flexibility in terms of chemical composition and hence in terms of the physicochemical properties achievable in the course of curing, particularly with regard to the achievable bonding strength. In particular, the curable adhesive to be specified ought also as far as possible to be able to be produced from components which are used for conventional curable adhesives.

A supplementary object of the present invention was to provide an advantageous reactive adhesive tape or pressure-sensitive adhesive tape. An additional object of the present invention was to specify an advantageous use of such curable pressure-sensitive adhesives and pressure-sensitive adhesive tapes produced from them for the bonding of two or more components.

The inventors of the present invention have now found that the objects described above can be achieved, surprisingly, if epoxy-modified nitrile rubbers are used in epoxide-based curable pressure-sensitive adhesives which cure via a cationic photoinitiator, as defined in the claims. As a result, surprisingly, curable pressure-sensitive adhesives are obtained which possess advantageous pressure-sensitive adhesive properties and also have a high bonding strength in the cured state. This is particularly surprising because other nitrile rubber-based additives in the prior art for curable adhesives which are not pressure-sensitive adhesives have been used as additives for retarding the curing reaction, as is disclosed in EP 0429250 A2. Accordingly, an improvement in the pressure-sensitive adhesive properties was not anticipated by the skilled person, while the boost observed to the bonding strength is indeed entirely unexpected in light of the curing-hindering effect of the compounds of the generic type.

The objects stated above are therefore achieved by the subject matter of the invention, as defined in the claims. Preferred configurations according to the invention are evident from the dependent claims and from the observations that follow.

Embodiments referred to below as preferred are combined, in particularly preferred embodiments, with features of other embodiments referred to as preferred. Especially preferred, therefore, are combinations of two or more of the embodiments referred to below as particularly preferred. Likewise preferred are embodiments in which a feature of one embodiment that is referred to to any extent as being preferred is combined with one or more further features of other embodiments which are referred to to any extent as being preferred. Features of preferred pressure-sensitive adhesive tapes and uses are apparent from the features of preferred curable pressure-sensitive adhesives.

Where, below, both specific amounts or fractions of an element, for example the (co)polymers or the polymerizable epoxide compounds, and preferred configurations of the element are disclosed, the specific amounts or fractions of the elements with preferred configuration are also disclosed, in particular. Moreover, in the case of the corresponding specific total amounts or total fractions of the elements, it is disclosed that at least some of the elements may have preferred configuration and also, in particular, that elements of preferred configuration may be present again in the specific amounts or fractions within the specific total amounts or total fractions.

The invention relates to a curable pressure-sensitive adhesive, comprising, based on the total mass of the curable pressure-sensitive adhesive:
a) one or more film-forming (co)polymers in a combined mass fraction in the range from 20% to 60%,
b) one or more polymerizable epoxide compounds in a combined mass fraction in the range from 20% to 60%, the epoxide compounds being selected from the group consisting of monomeric and oligomeric epoxide compounds,
c) one or more cationic photoinitiators in a combined mass fraction in the range from 0.5% to 7%, and
d) one or more epoxy-modified nitrile rubbers in a combined mass fraction in the range from 3% to 30%.

Curable adhesives in general and curable pressure-sensitive adhesives in particular are comprehensively known to the skilled person, as described above, from the prior art; the individual components indicated above are also known in isolation to the skilled person and are available commercially in different variations from different suppliers—below, moreover, preferred and illustrative representatives of the individual components are disclosed.

In agreement with the understanding of the skilled person, these above-defined constituents are used in each case as “one or more”. The designation “one or more” refers here, in a manner customary within the sector, to the chemical nature of the compounds in question and not to their amount of substance. For example, the polymerizable epoxide compound in the curable pressure-sensitive adhesive may comprise exclusively epoxycyclohexylmethyl 3′,4′-epoxycyclohexanecarboxylate, which would mean that the curable pressure-sensitive adhesive comprises a multiplicity of the molecules in question.

In a manner customary in the sector, mass fractions are reported as combined mass fractions of the one or of the two or more components, expressing the fact that the mass fraction of the components configured accordingly, taken together, meets the corresponding criteria; in the absence of indications to the contrary, the mass of the curable pressure-sensitive adhesive is the reference system in each case.

The curable adhesive of the invention is curable. As a result of the facility for curing, the curable adhesive is able to function as a structural adhesive after curing. According to DIN EN 923:2016-03, structural adhesives are demonstrably suitable for producing load-bearing constructions in which the adhesive bond can be stressed over relatively long periods of time with a high percentage value of the maximum breaking force without failure (according to the ASTM definition: “bonding agents used for transferring required loads between adherends exposed to service environments typical for the structure involved”). They are, accordingly, adhesives for bonds which can be highly stressed chemically and physically and which in the cured state contribute to the strengthening of the adhesive tapes.

A pressure-sensitive adhesive (PSA), in agreement with the understanding of the skilled person, irrespective of any curability, is an adhesive which possesses pressure-sensitive adhesive properties, i.e.

has the capacity to enter into a durable bond with respect to a substrate even under relatively weak applied pressure. Corresponding pressure-sensitive adhesive tapes are typically redetachable from the substrate substantially without residue after use, and in general have a permanent intrinsic tack even at room temperature, meaning that they have a certain viscosity and touch-tackiness, so that they wet the surface of a substrate even under low applied pressure. The pressure-sensitive adhesiveness of a pressure-sensitive adhesive tape is a product of the use as adhesive of a pressure-sensitive adhesive. Without wishing to be tied to this theory, it is frequently assumed that a pressure-sensitive adhesive may be considered to be a fluid of extremely high viscosity with an elastic component, accordingly having characteristic viscoelastic properties which lead to the above-described durable intrinsic tackiness and pressure-sensitive adhesive capability. It is assumed that with such PSAs, on mechanical deformation, there are viscous flow processes and there is development of elastic forces of resilience. The viscous flow component serves to achieve adhesion here, while the elastic forces of resilience component is needed in particular for the achievement of cohesion. The relationships between the rheology and the pressure-sensitive adhesiveness are known in the prior art and described for example in Satas, “Handbook of Pressure Sensitive Adhesives Technology”, Third Edition (1999), pages 153 to 203. To characterize the extent of the elastic and viscous components, it is usual to employ the storage modulus (G′) and the loss modulus (G″), which may be ascertained by dynamic mechanical analysis (DMA), using a rheometer, for example, as disclosed for example in WO 2015/189323. For the purposes of the present invention, an adhesive is understood preferably to have pressure-sensitive adhesiveness and hence to be a pressure-sensitive adhesive when at a temperature of 23° C. in the deformation frequency range from 10° to 10¹ rad/sec, G′ and G″ are each situated at least partly within the range from 10³ to 10⁷ Pa.

Below, the components contained in the curable pressure-sensitive adhesive of the invention are explained in more detail. Accordingly, the inventors have succeeded in identifying respective particularly preferred configurations and mass fractions for the individual components, allowing performance-capable curable adhesives of the invention to be obtained.

The curable pressure-sensitive adhesive of the invention comprises one or more (co)polymers. The skilled person understands that the (co)polymers in a customary manner have the role of the film-former, which is important in particular since the intention is to obtain a pressure-sensitive adhesive. Preferred here is a curable pressure-sensitive adhesive of the invention, wherein the one or the two or more (co)polymers are selected from the group consisting of poly(meth)acrylates, polyurethanes, polyvinylacetals, such as e.g. polyvinylbutyral, polysiloxanes, synthetic rubbers, polyesters, phenoxy polymers, polyvinyl alcohols, polyvinyl alcohol copolymers, and alkene-vinyl acetate copolymers, preferably selected from the group consisting of poly(meth)acrylates, phenoxy polymers, polyvinyl alcohols, polyvinyl alcohol copolymers, polyvinylacetals, such as e.g. polyvinylbutyral, and ethylene-vinyl acetate copolymers (EVA or EVAC, poly(ethylene-co-vinyl acetate)), especially selected from the group consisting of poly(meth)acrylates, phenoxy polymers and ethylene-vinyl acetate copolymers.

Additionally or alternatively it is also possible as (co)polymers to use block copolymers, for example (meth)acrylate block copolymers. Corresponding examples are disclosed for example in the documents US 2011003947 A1, US 20080200589 A1, US 2007078236 A1, US 2007078236 A1, US 2012196952 A1, US 2016032157 A1,US 2008146747 A1 and US 2016230054 A1.

The number-average molar masses Mₙ of the (co)polymers are preferably in a range from 50 000 to 25 10 000 000 g/mol, more preferably in a range from 100 000 to 5 000 000 g/mol, very preferably in a range from 150 000 to 2 000 000 g/mol. The figures for the number-average molar mass Mn are based here on the determination by gel permeation chromatography (GPC). The determination is made on 100 pl of clear-filtered sample (sample concentration 4 g/l). The eluent used is tetrahydrofuran with 0.1% by volume of trifluoroacetic acid. The measurement takes place at 25° C. The pre-column used is a column of type PSS-SDV, 5 μm, 10³ Å, 8.0 mm*50 mm (details here and below in the following order: type, particle size, porosity, internal diameter* length; 1 Å=10⁻¹⁰ m). Separation takes place here using a combination of the columns of type PSS-SDV, 5 μm, 10³ Å and also 10⁵ Å and 10⁶ Å each of 8.0 mm*300 mm (columns from Polymer Standards Service; detection by means of Shodex RI71 differential refractometer). The flow rate is 1.0 ml per minute. Calibration takes place in the case of polyacrylates against PMMA standards (polymethyl methacrylate calibration) and otherwise (resins, elastomers) against PS standards (polystyrene calibration).

Irrespective of the specific selection of the (co-)polymers, preference is given to a curable pressure-sensitive adhesive of the invention wherein the combined mass fraction of the (co-)polymers in the curable pressure-sensitive adhesive is in the range from 20% to 55%, preferably in the range from 20% to 50%, more preferably in the range from 25% 50%, very preferably in the range from 25% to 45%, most preferably in the range from 30% to 45%, based on the mass of the curable pressure-sensitive adhesive.

As well as the (co-)polymers, the curable pressure-sensitive adhesive of the invention also comprises at least one polymerizable epoxide compound. These epoxide compounds together form that part of the curable pressure-sensitive adhesive which is frequently referred to by the skilled person as reactive resin.

In agreement with the understanding of the skilled person, the expression “polymerizable” here refers to the capacity of these compounds, where appropriate after suitable activation, to enter into a polymerization reaction. In the case of the polymerizable epoxide compounds, the polymerizability is enabled, for example, by the epoxide groups.

In agreement with the understanding of the skilled person, epoxide compounds are compounds which carry at least one oxirane group. The skilled person understands that the epoxy-modified nitrile rubbers for use in the curable pressure-sensitive adhesives of the invention also carry an oxirane group and accordingly are epoxide-containing compounds which are able to participate in polymerization reactions. For the purposes of the present invention, however, these epoxy-modified nitrile rubbers are not polymerizable epoxide compounds as per point b), since these are defined additionally as being monomeric or oligomeric epoxide compounds. In contrast to this, the epoxy-modified nitrile rubbers, as typical for rubbers, are polymeric compounds which accordingly are not part of the polymerizable epoxide compounds under point b). Against this background, particular preference is given to curable pressure-sensitive adhesives of the invention wherein the one or the two or more polymerizable epoxide compounds are selected from the group consisting of polymerizable epoxide compounds having a weight-average molar mass M_{w}, measured by means of GPC, in the range from 300 to 2000 g/mol, preferably in the range from 300 to 1500 g/mol, more preferably in the range from 350 to 1300 g/mol. Particularly preferred additionally or alternatively as well is a curable pressure-sensitive adhesive of the invention wherein the one or the two or more polymerizable epoxide compounds are selected from the group consisting of polymerizable epoxide compounds having a weight-average molar mass M_{w}, measured by means of GPC, of 2000 g/mol or less.

The polymerizable epoxide compounds may for example be aromatic or aliphatic, more particularly cycloaliphatic, in nature. Polymerizable epoxide compounds frequently have on average at least two epoxide groups per molecule, preferably more than two epoxide groups per molecule. Preferred accordingly is a curable pressure-sensitive adhesive of the invention wherein the one or the two or more polymerizable epoxide compounds are selected from the group consisting of epoxide compounds having two or more epoxide groups, preferably two epoxide groups.

Illustrative polymerizable epoxide compounds comprise epoxycyclohexane carboxylates, such as, for example, 4-epoxycyclohexylmethyl 3,4-epoxycyclohexanecarboxylate, 3,4-epoxy-2-methylcyclohexyl-methyl 3,4-epoxy-2-methylcyclohexanecarboxylate and bis(3,4-epoxy-6-methylcyclohexylmethyl) adipate. Further examples of polymerizable epoxide compounds are, for example, disclosed in U.S. Pat. No. 3,117,099 A. Further polymerizable epoxide compounds particularly useful in the application of this invention comprise glycidyl ether monomers, as are disclosed for example in US 3,018,262. Examples are the glycidyl ethers of polyhydric phenols, obtained by reacting a polyhydric phenol with an excess of chlorohydrin, such as epichlorohydrin (e.g. the diglycidyl ether of 2,2-bis(2,3-epoxypropoxyphenol)propane). In particular, diglycidyl ethers of bisphenols, such as e.g. bisphenol-A (4,4″-(propane-2,2-diyOdiphenol) and bisphenol-F (bis(4-hydroxyphenyl)methane). Such reaction products are available commercially in different molecular weights and aggregate states (for example, so-called type 1 to type 10 BADGE resins). Typical examples of liquid bisphenol-A diglycidyl ethers are Epikote 828, D.E.R.331, Araldite GY 250CH and Epon 828. Typical solid BADGE resins are Araldite GT6071, GT7072, Epon 1001 and D.E.R. 662. Further reaction products of phenols with epichlorohydrin are the phenol and cresol novolac resins such as the Epiclon types or Araldite EPN and ECN types (e.g. ECN1273), for example.

Preferred here in the estimation of the inventors is a curable pressure-sensitive adhesive of the invention wherein the one or the two or more polymerizable epoxide compounds are selected from the group consisting of epoxide compounds having at least one cycloaliphatic group, more particularly a cyclohexyl group or dicyclopentadienyl group. Preferred, additionally or alternatively, is a curable pressure-sensitive adhesive of the invention wherein the one or the two or more polymerizable epoxide compounds are selected from the group consisting of bisphenol-A diglycidyl ethers and bisphenol-F diglycidyl ethers, preferably bisphenol-A diglycidyl ethers.

In the estimation of the inventors, particularly advantageous curable pressure-sensitive adhesives may be obtained by using two or more different polymerizable epoxide compounds, especially if they differ at room temperature in terms of their aggregate state. Preferred is a curable pressure-sensitive adhesive of the invention which comprises one or more polymerizable epoxide compounds selected from the group of epoxide compounds which at 25° C. are solids or substances of high viscosity, having a dynamic viscosity of 50 Pa s or more, preferably 100 Pa s or more, more preferably 150 Pa s or more, and/or which comprises one or more polymerizable epoxide compounds selected from the group of epoxide compounds which at 25° C. are a liquid having a dynamic viscosity of 40 Pa s or less, preferably 20 Pa s or less, very preferably 10 Pa s or less. For the purposes of the present invention, the dynamic viscosity is determined here according to DIN 53019-1 from 2008; at 25° C., with a shear rate of 1 s⁻¹.

Preferred, irrespective of the specific selection of the polymerizable epoxide compounds, is a curable pressure-sensitive adhesive of the invention wherein the combined mass fraction of the polymerizable epoxide compounds in the curable pressure-sensitive adhesive is in the range from 30% to 60%, preferably in the range from 30% to 55%, more preferably in the range from 35% to 55%, very preferably in the range from 35% to 50%, based on the mass of the curable pressure-sensitive adhesive.

As a further constituent, the curable pressure-sensitive adhesive of the invention comprises at least one epoxy-modified nitrile rubber. Epoxy-modified nitrile rubbers are, in particular, liquid polymeric epoxy resins, generally of high viscosity, having a basic framework of nitrile rubber modified with epoxide groups, which are incorporated by modification with epoxy resins and/or epoxide prepolymers, with the mass fraction of the nitrile rubber being preferably in the range from 5% to 50%, more preferably in the range from 10% 40%, based on the mass of the epoxy-modified nitrile rubber. In agreement with the understanding of the skilled person, the expression “epoxy-modified nitrile rubber” therefore refers to reaction products of functionalized or non-functionalized nitrile rubbers with epoxy resins. In order to achieve high miscibility with the relatively polar epoxy resins or epoxide prepolymers, the nitrile rubber polymers on which the epoxy-modified nitrile rubber is based contain a mass fraction of acrylonitrile of at least 20% and not more than 50%, the mass fraction of the acrylonitrile being situated more particularly in the range from 25% to 40%. The expression “nitrile rubber” is known to the skilled person and refers to butadiene-acrylonitrile copolymers. To join the epoxide groups onto the butadiene-acrylonitrile copolymer, it is possible during the preparation to copolymerize one or more further monomers having a functional group, for example a carboxylic acid group, for example acrylic acid. From the carboxylic acid and the nitrile rubbers, so-called carboxy-terminated nitrile rubbers (CTBNs) or carboxylated nitrile rubbers are obtained as precursors of the epoxy-modified nitrile rubbers, where the carboxylic acid groups may alternatively or additionally be present in the polymer chain as well. CTBNs are also available commercially and are offered, for example, under the trade name Hycar from B. F. Goodrich. They have, for example, weight-average molar masses in the range from 2000 to 5000 g/mol and acrylonitrile contents in the range from 10% to 30%. Specific examples are Hycar CTBN 1300×8, 1300×13 or 1300×15. Through the reaction of CTBNs with epoxy resins or epoxide prepolymers, it is possible under suitable conditions to obtain epoxy-modified nitrile rubbers, for example epoxy-terminated nitrile rubbers (ETBNs). Commercially, such epoxy-modified nitrile rubbers, especially ETBNs, are available for example from Emerald Materials under the name HYPRO ETBN (formerly Hycar ETBN), for example under the trade names Hypro 1300X40 ETBN, Hypro 1300X63 ETBN and Hypro 1300X68 ETBN. Moreover, such epoxy-modified nitrile rubbers are available from Schill+Seilacher “Struktol” GmbH under the trade name Polydis, for example under the designation Polydis 3604 or 3605, 3606, 3610, 3611, 3614, 3615, 3616, 3618, 3633, 3636, 3652, 3670, 3691, 3693, 3694 S, 3695 or 3696 S. Epoxy-modified nitrile rubbers are occasionally also offered in the form of nitrile rubber-modified epoxy resin, with the designation in particular being a question of the point of view and being guided in many cases, in the estimation of the inventors, primarily by the mass fraction of the components reacted with one another.

Preference is given in the estimation of the inventors to a curable pressure-sensitive adhesive of the invention wherein the one or the two or more epoxy-modified nitrile rubbers are selected from the group consisting of epoxy-modified nitrile rubbers having an average functionality of 2 or more, preferably 2.5 or more, more preferably 3 or more. Preferred, additionally or alternatively, is a curable pressure-sensitive adhesive of the invention wherein the one or the two or more epoxy-modified nitrile rubbers are selected from the group consisting of epoxy-modified nitrile rubbers having epoxide groups arranged terminally and/or in the chain. Particularly preferred in the estimation of the inventors, in particular, is also a curable pressure-sensitive adhesive of the invention wherein the one or the two or more epoxy-modified nitrile rubbers are selected from the group consisting of epoxy-modified nitrile rubbers having a weight-average molar mass M_{w}, measured by means of GPC, in the range from 5000 to 35 000 g/mol, preferably in the range from 10 000 to 30 000 g/mol, more preferably in the range from 15 000 to 25 000 g/mol.

The inventors have determined that, surprisingly, epoxy-modified nitrile rubbers which lead to improved peel adhesions are, in particular, those which exhibit at least a bimodal distribution in the GPC. Without wishing to be tied to this theory, the inventors assume that in this way a balanced ratio between adhesive and cohesive properties is achieved. By “at least bimodal”, the inventors understand GPC curves which contain more than one maximum or whose mathematical derivative of the molecular weight distribution intersects the x-axis at least twice. Preferred, therefore, is a curable pressure-sensitive adhesive of the invention wherein the one or the two or more epoxy-modified nitrile rubbers are selected from the group consisting of epoxy-modified nitrile rubbers having an at least bimodal distribution of the weight-average molar mass.

Since GPC results are only able to provide relative information regarding the molecular weight, and since the values measured and the quality of resolution are heavily dependent on the nature of the columns, the weight-average molar mass distributions which are regarded as preferable may be characterized relative to the high point of the highest-molecular components. Particularly preferred, indeed, are those epoxy-modified nitrile rubbers which in the GPC, as well as the highest-molecular high point, exhibit at least two further maxima in the molar mass. Such specific molecular weight distributions may be obtained, for example, in processes in which CTBNs are reacted with epoxy resins and chain-extended via addition of diols or polyols such as bisphenol-A, for example.

Particularly preferred, additionally or alternatively, is also a curable pressure-sensitive adhesive of the invention wherein the one or the two or more epoxy-modified nitrile rubbers are selected from the group consisting of epoxy-modified nitrile rubbers having a weight-average molar mass Mw, measured by means of GPC, of more than 2000 g/mol.

Irrespective of the specific selection of the epoxy-modified nitrile rubbers, preference is given to a curable pressure-sensitive adhesive of the invention wherein the combined mass fraction of the epoxy-modified nitrile rubbers in the curable pressure-sensitive adhesive is in the range from 3.5% to 25%, preferably in the range from 4% to 20%, more preferably in the range from 4.5% 18%, based on the mass of the curable pressure-sensitive adhesive.

The curable pressure-sensitive adhesives of the invention comprise at least one cationic photoinitiator. Such cationic photoinitiators are known to the skilled person on the basis of their common general knowledge and are frequently used particularly in the area of epoxide-based reactive adhesives. The skilled person tailors the catalyst system used for curing substantially to the application requirements, especially to the wavelength intended for subsequent activation of the curing, and to the polymerizable epoxide compounds used.

Initiators which can be used for such cationic, radiation-based, i.e. frequently UV-induced, curing of epoxide compounds are, in particular, sulfonium-, iodonium- and metallocene-based systems. For examples of sulfonium-based cations, reference may be made to the observations in U.S. Pat. No. 6,908,722 B1. Examples of anions which serve as counterions for the cations stated above include tetrafluoroborate, tetraphenylborate, hexafluorophosphate, perchlorate, tetrachloroferrate, hexafluoroarsenate, hexafluoroantimonate, pentafluorohydroxyantimonate, hexachloroantimonate, tetrakispentafluorophenylborate, tetrakis-(pentafluoromethylphenyl)-borate, bi-(trifluoromethylsulfonyl)-amides and tris-(trifluoromethylsulfonyl)-methides. Moreover, especially for iodonium-based initiators, conceivable anions also include chloride, bromide or iodide, although preferred initiators are those which are substantially free from chlorine and bromine. An effective example of such a system is, for example, triphenylsulfonium hexafluoroantimonate.

Further suitable initiators are disclosed for example in U.S. Pat. Nos. 3,729,313 A, 3,741,769 A, 4,250,053 A, 4,394,403 A, 4,231,951 A, 4,256,828 A, 4,058,401 A, 4,138,255 A and 2010/063221 A1.

Specific examples of sulfonium salts which can be used are particularly triarylsulfonium salts, for example triphenylsulfonium hexafluoroarsenate, triphenylsulfonium hexafluoroborate, triphenylsulfonium tetrafluoroborate, triphenylsulfonium tetrakis-(pentafluorobenzyl)-borate, methyldiphenylsulfonium tetrafluoroborate, methyldiphenylsulfonium tetrakis-(pentafluorobenzyl)-borate, dimethylphenylsulfonium hexafluorophosphate, triphenylsulfonium hexafluorophosphate, triphenylsulfonium hexafluoroantimonate, diphenylnaphthylsulfonium hexafluoroarsenate, tritolylsulfonium hexafluorophosphate, anisyldiphenyl-sulfonium hexafluoroantimonate, 4-butoxyphenyldiphenylsulfonium tetrafluoroborate, 4-chlorophenyl-diphenylsulfonium hexafluoroantimonate, tris-(4-phenoxyphenyl)-sulfonium hexafluorophosphate, di-(4-ethoxphenyl)-methylsulfonium hexafluoroarsenate, 4-acetylphenyldiphenylsulfonium tetrafluoroborate, 4-acetylphenyldiphenylsulfon ium tetrakis-(pentafluorobenzyl)-borate, tris-(4-thiomethoxyphenyI)-sulfonium hexafluorophosphate, di-(methoxysulfonylphenyl)-methylsulfonium hexafluoroantimonate, di-(methoxy-naphthyl)-methylsulfonium tetrafluoroborate, di-(methoxynaphthyl)-methylsulfonium tetrakis-(penta-fluorobenzyl)-borate, di-(carbomethoxyphenyI)-methylsulfonium hexafluorophosphate, (4-octyloxyphenyl)-diphenylsulfonium tetrakis-(3,5-bis-trifluoromethylphenyl)-borate, tris-[4-(4-acetylphenyl)-thiophenyl]-sulfonium tetrakis-(pentafluorophenyl)-borate, tris-(dodecylphenyl)-sulfonium tetrakis-(3,5-bis-trifluoromethylphenyl)-borate, 4-acetamidophenyldiphenylsulfonium tetrafluoroborate, 4-acetamidophenyldiphenylsulfonium tetrakis-(pentafluorobenzyl)-borate, dimethylnaphthylsulfonium hexafluorophosphate, trifluoromethyldiphenyl-sulfonium tetrafluoroborate, trifluoromethyldiphenylsulfonium tetrakis-(pentafluorobenzyl)-borate, phenylmethylbenzylsulfonium hexafluorophosphate, 5-methylthian-threnium hexa-fluorophosphate, 10-phenyl-9,9-dimethylthioxanthenium hexafluorophosphate, 10-phenyl-9-oxoth ioxanthenium tetrafluoroborate, 10-phenyl-9-oxothioxanthenium tetrakis-(pentafluorobenzyl)-borate, 5-methyl-10-oxothianthrenium tetrafluoroborate, 5-methyl-10-oxothianthrenium tetrakis-(pentafluorobenzyl)-borate and 5-methyl-10,10-dioxothianthrenium hexafluorophosphate.

Specific examples of iodonium salts which can be used are diphenyliodonium tetrafluoroborate, di-(4-methylphenyl)-iodonium tetrafluoroborate, phenyl-4-methylphenyliodonium tetrafluoroborate, di-(4-chlorphenyl)-iodonium hexafluorophosphate, dinaphthyliodonium tetrafluoroborate, di-(4-trifluormethyl-phenyl)-iodonium tetrafluoroborate, diphenyliodonium hexafluorophosphate, di-(4-methylphenyl)-iodonium hexafluorophosphate, diphenyliodonium hexafluoroarsenate, di-(4-phenoxyphenyl)-iodonium tetrafluoroborate, phenyl-2-thienyliodonium hexafluorophosphate, 3,5-dimethylpyrazolyl-4-phenyliodonium hexafluorophosphate, diphenyliodonium hexafluoroantimonate, 2,2′-diphenyliodonium tetrafluoroborate, di-(2,4-dichlorophenyl)-iodonium hexafluorophosphate, di-(4-bromophenyl)-iodonium hexafluorophosphate, di-(4-methoxyphenyl)-iodonium hexafluorophosphate, di-(3-carboxyphenyl)-iodonium hexafluorophosphate, di-(3-methoxycarbonylphenyl)-iodonium hexafluorophosphate, di-(3-methoxysulfonylphenyl)-iodonium hexafluorophosphate, di-(4-acetamidophenyl)-iodonium hexafluoro-phosphate, di-(2-benzothienyl)-iodonium hexafluorophosphate, diaryliodonium tristrifluoromethylsulfonylmethide such as diphenyliodonium hexafluoroantimonate, diaryliodonium tetrakis-(pentafluorophenyl)-borate such as diphenyliodonium tetrakis-(pentafluorophenyl)-borate, [4-(2-hydroxy-n-tetradesiloxy)-phenyl]-phenyliodonium hexafluoroantimonate, [4-(2-hydroxy-n-tetradesiloxy)-phenyl]-phenyliodonium trifluorosulfonate, [4-(2-hydroxy-n-tetradesiloxy)-phenyl]-phenyliodonium hexafluorophosphate, [4-(2-hydroxy-n-tetradesiloxy)-phenyl]-phenyliodonium tetrakis-(pentafluorophenyl)-borate, bis-(4-tert-butylphenyl)-iodonium hexafluoroantimonate, bis-(4-tert-butylphenyl)-iodonium hexa-fluorophosphate, bis-(4-tert-butylphenyl)-iodonium trifluorosulfonate, bis-(4-tert-butylphenyl)-iodonium tetrafluoroborate, bis-(dodecylphenyl)-iodonium hexafluoroantimonate, bis-(dodecylphenyl)-iodonium tetrafluoroborate, bis-(dodecylphenyl)-iodonium hexafluorophosphate, bis-(dodecylphenyl)-iodonium trifluoromethylsulfonate, di-(dodecylphenyl)-iodonium hexafluoroantimonate, di-(dodecylphenyl)-iodonium triflate, diphenyliodonium bisulfate, 4,4′-dichlorodiphenyliodonium bisulfate, 4,4′-dibromodiphenyliodonium bisulfate, 3,3′-dinitrodiphenyliodonium bisulfate, 4,4′-dimethyldiphenyliodonium bisulfate, 4,4′-bis-succinimidodiphenyliodonium bisulfate, 3-nitrodiphenyliodonium bisulfate, 4,4′-dimethoxydiphenyliodonium bisulfate, bis-(dodecylphenyl)-iodonium tetrakis-(pentafluorophenyl)-borate, (4-octyloxyphenyl)-phenyliodonium tetrakis-(3,5-bis-trifluoromethylphenyI)-borate and (tolylcumyl)-iodonium tetrakis-(pentafluorophenyl)-borate, and ferrocenium salts (see for example EP 0 542 716 B1) such as η5-(2,4-cyclopentadien-1-yl)-[(1,2,3,4,5,6,9)-(1-methylethyl)-benzenel]iron.

Such catalytic photoinitiators are typically used individually or as a combination of two or more photoinitiators. When photoinitiators are used, in the case of curable adhesives from the prior art, in particular, combinations with so-called sensitizers for adapting the activation wavelength of the photoinitiation system to the chosen emission spectrum are also very useful, and are disclosed, for example, in the textbook “Industrial Photoinitiators: A technical guide” 2010 by A.W. Green.

Certain cationic photoinitiators, for example the photoinitiator commercially available under the trade name Deuteron UV 1242, reacts only at relatively short wavelength ranges in the region of 222 to 250 nm. Activation by means of a typical UV-LED, which would be greatly preferred from a performance standpoint, is not possible here, or at least not efficiently, since the emission maximum of typical UV-LEDs is situated at a wavelength of about 365 nm. In order to be able nevertheless to activate these cationic photoinitiators using typical UV-LEDs, recourse is had to the approach, described in the literature, of “radical promoter cationic curing”. For this purpose, a sensitizer is added in the form of a radical initiator, as available commercially, for example, under the trade name Omnirad BDK or Irgacure 651, which breaks down on excitation at relatively high wavelengths, for example with a wavelength typical for UV-LEDs of 365 nm. The radicals formed in this way, and/or other active species, activate the cationic initiator, which ultimately sets the epoxide curing in train. In these cases where sensitizers are used, the mass fraction of cationic photoinitiators in the curable pressure-sensitive adhesive is typically not more than 4% but at least 0.1%, and is preferably in the range from 0.5% to 2%. The mass fraction of sensitizers here is customarily not more than 3% and preferably in the range from 0.5% to 2%.

Largely independently of the selection of the specific cationic initiator, preference is given first to a curable pressure-sensitive adhesive of the invention wherein the combined mass fraction of the cationic photoinitiators in the curable pressure-sensitive adhesive is in the range from 0.5% to 4%, preferably in the range from 5% to 3%, more preferably in the range from 0.5% to 2%, based on the mass of the curable pressure-sensitive adhesive.

As is further explained below, however, it is desirable to the knowledge of the inventors, especially when sensitizers are not being used, to employ relatively large amounts of the cationic photoinitiators in many cases. Preferred accordingly—additionally or alternatively—is a curable pressure-sensitive adhesive of the invention wherein the combined mass fraction of the cationic photoinitiators in the curable pressure-sensitive adhesive is in the range from 0.75% to 6%, preferably in the range from 1% to 5%, more preferably in the range from 1.25% to 3%, based on the mass of the curable pressure-sensitive adhesive.

The inventors have recognized that the very advantageous use of epoxy-modified nitrile rubbers, which in combination with the other constituents results in performance-capable curable pressure-sensitive adhesives, may reduce the activity of sensitizers, especially sensitizers which function via a radical mechanism. Hence it is observed that curing activated via a sensitizer with typical photoinitiator systems in certain cases does not operate, or no longer operates sufficiently, if the chosen mass fraction of epoxy-modified nitrile rubber is very high. Without wishing to be tied to this theory, the inventors assume that the C═C double bonds present in the nitrile rubber are able to scavenge the radicals formed and these radicals are no longer available in sufficient number to kick off the cationic initiator and so to initiate the curing process.

A solution to this problem, and the curing of the curable pressure-sensitive adhesive of the invention, are also possible for the skilled person. A sharp increase in the amount of sensitizers, in order to counteract the reduction in the concentration of radicals when large amounts of epoxy-modified nitrile rubbers are present, is in many cases unwanted or not useful, however. Without adaptation of the cationic photoinitiator, it would be necessary, correspondingly, to employ activation with electromagnetic radiation of a wavelength matching the cationic photoinitiator, in order to bring about effective curing at high levels of epoxy-modified nitrile rubbers with these cationic photoinitiators; at least in theory, this presents no problem.

In practice, however, there is a great interest in using cost-effective and readily available UV-LEDs whose emission maximum is situated usually at a wavelength of about 365 nm. Because of the reduced activity of sensitizers, however, this is no longer readily achievable for all cationic photoinitiators. The inventors therefore propose that in order to obtain a curable pressure-sensitive adhesive of the invention which can be reliably cured with UV-LEDs even at high levels of epoxy-modified nitrile rubbers, i.e. in mass fractions of 10% or more, especially of 15% or more, photoinitiators ought to be used which activate at a wavelength at which UV-LEDs still exhibit a marked emission. Preferred accordingly is a curable pressure-sensitive adhesive of the invention wherein the one or the two or more cationic photoinitiators have the highest-wavelength absorption maximum at a wavelength of 290 nm or more, preferably of 320 nm or more, more preferably of 340 nm or more, very preferably of 360 nm or more. The corresponding absorption characteristics and the resulting wavelength ranges are regularly tabulated by the manufacturer for commercially available cationic photoinitiators and are readily available to the skilled person, and the position of the highest-wavelength absorption maximum may be determined in case of doubt by measuring the transmission with a UV-VIS spectrometer, the cationic photoinitiator being used in solution in a suitable solvent, and the concentration of the cationic photoinitiator being usefully to be low enough to allow the highest-wavelength absorption maximum to be clearly identified to a sufficient extent with the measuring system selected. Against this background, particular preference is given to a curable pressure-sensitive adhesive of the invention wherein the one or the two or more cationic photoinitiators are selected from the group consisting of cationic photoinitiators whose counterion is selected from the group consisting of hexafluorophosphate, hexafluoroantimonate and tetrakispentafluorophenylborate.

The skilled person understands that when using cationic photoinitiators which are already designed for the desired wavelength, it makes sense, in view of the reduced activity of sensitizers at high levels of epoxy-modified nitrile rubbers, to do entirely without the addition of such sensitizers. Preferred in this case is a curable pressure-sensitive adhesive of the invention wherein the combined mass fraction of sensitizers in the curable pressure-sensitive adhesive is 0.1% or less, preferably 0.01% or less, more preferably 0.001% or less, based on the mass of the curable pressure-sensitive adhesive; with very particular preference, the curable pressure-sensitive adhesive is substantially free of sensitizers, and this is preferable especially when using high levels of epoxy-modified nitrile rubbers, i.e. in mass fractions of 10% or more, especially of 15% or more.

In their own experiments, the inventors found that especially in the absence of sensitizers, it is useful to tailor the amount of cationic photoinitiator to the amount of epoxy-modified nitrile rubbers in order to achieve excellent curability and an advantageous bonding strength. The inventors identified it as being advantageous for the amount of cationic photoinitiator chosen to be not too low compared to the epoxy-modified nitrile rubbers. Preferred initially, therefore, is a curable pressure-sensitive adhesive of the invention wherein the ratio of the combined mass fraction of the cationic photoinitiators divided by the combined mass fraction of the epoxy-modified nitrile rubbers is 0.06 or more, preferably 0.07 or more, more preferably 0.08 or more, and/or wherein the ratio of the combined mass of the cationic photoinitiators to the combined mass of the epoxy-modified nitrile rubbers is 6:100 or more, preferably 7:100 or more, more preferably 8:100 or more.

Because the skilled person has a fundamental interest in not choosing the level of cationic photoinitiators higher than is necessary, preferred quantity ranges come about on this basis, according to the estimation of the inventors. Preferred, in fact, is a curable pressure-sensitive adhesive of the invention wherein the ratio of the combined mass fraction of the cationic photoinitiators divided by the combined mass fraction of the epoxy-modified nitrile rubbers is in the range from 0.06 to 0.6, preferably in the range from 0.07 to 0.5, more preferably in the range from 0.08 to 0.4, and/or wherein the ratio of the combined mass of the cationic photoinitiators to the combined mass of the epoxy-modified nitrile rubbers is in the range from 6:100 to 60:100, preferably in the range from 7:100 to 50:100, more preferably in the range from 8:100 to 40:100.

As a further surprising effect, the inventors have found that the technical adhesive properties of curable pressure-sensitive adhesives of the invention can be improved through the addition of dyes, with advantageous effects having been observed particularly with blue dyes. Preferred against this background is a curable pressure-sensitive adhesive of the invention which comprises one or more dyes, preferably in a combined mass fraction in the range from 0.05% to 1.0%, preferably in the range from 0.1% to 0.75%, more preferably in the range from 0.2% to 0.5%. Particularly preferred accordingly is a curable pressure-sensitive adhesive of the invention wherein the one or the two or more dyes are selected from the group consisting of blue dyes.

In specific applications, an opacity (“haze”) may be desired for the curable adhesive of the invention or for the adhesive tape comprising the curable adhesives of the invention, comprising one or more dyes. Such specific applications are, for example, adhesive tapes for the electrical insulation of an article, such as battery cells, for example. Here, a certain opacity is desirable in order to conceal visual defects such as scratches, for example. Preferred accordingly is a curable adhesive of the invention which as well as one or more dyes further comprises one or more additives for increasing the opacity.

Preferred additionally or alternatively is a curable pressure-sensitive adhesive of the invention wherein the one or the two or more dyes are selected from the group consisting of 1,4-bis(mesitylamino)anthraquinone (CAS: 116-75-6), Benzoyl Leuco-Methylene Blue (CAS: 1249-97-4), Leuco Crystal Violet (CAS: 603-48-5), Crystal Violet Lactone (CAS: 1552-42-7), Ethyl Violet (CAS: 2390-59-2), Methyl Violet (CAS: 8004-87-3), Methyl Green (CAS: 7114-03-6), Ethyl Green (CAS: 14855-76-6), Nile Blue (CAS: 2381-85-3 (hydrochloride), 3625-57-8 (sulfate) and CAS: 53340-16-2 (perchlorate)) and copper phthalocyanine (CAS 147-14-8), preferably selected from the group consisting of Benzoyl Leuco-Methylene Blue, Leuco-Crystal Violet, Crystal Violet Lactone, Ethyl Violet, Methyl Violet, Methyl Green, Ethyl Green, Nile Blue, 1,4-bis(mesitylamino)anthraquinone and copper phthalocyanine (CAS 147-14-8). Particularly preferred in each case is a curable pressure-sensitive adhesive of the invention wherein the one or the two or more dyes are selected from the group consisting of 1,4-bis(mesitylamino)anthraquinone, Ethyl Violet and copper phthalocyanine.

It may be seen as an advantage of the curable pressure-sensitive adhesives of the invention that they are very flexible in terms of the presence of further components, it being possible advantageously as a result for the physicochemical properties to be tailored in a particularly targeted way to the respective requirements of the applications. Preferred, for example, is a curable pressure-sensitive adhesive of the invention which comprises one or more polyols, preferably in a combined mass fraction in the range from 0.5% to 15%, preferably in the range from 1′)/0 to 10%. Preferred additionally or alternatively is also a curable pressure-sensitive adhesive of the invention which comprises one or more further additives, preferably in a combined mass fraction in the range from 0.1% to 50%, more preferably in the range from 0.2% to 40%, based on the mass of the curable pressure-sensitive adhesive, and/or wherein the one or the two or more further additives are preferably selected from the group consisting of tackifier resins, ageing inhibitors, light stabilizers, UV absorbers, rheological additives and additives for increasing the opacity.

In a preferred embodiment, the curable adhesive of the invention comprises one or more dyes and one or more additives for increasing the opacity. Having been found to be particularly advantageous in respect of adhesive curability, colour strength and hiding power are combinations of a combined mass fraction of not more than 0.3% of one or more dyes with a combined mass fraction of not more than 5% of one or more additives for increasing the capacity, based on the mass of the curable adhesive. Especially preferred are curable adhesives of the invention wherein the combined mass fraction of the dyes, more particularly selected from the group consisting of blue dyes, in the curable adhesive is in the range from 0.1% to 0.25% and the combined mass fraction of the additives for increasing the opacity, more particularly of titanium dioxide, is in the range from 0.1% to 0.3%, based on the mass of the curable adhesive.

A particular case of the further components which serve to adjust the properties of adhesives are insoluble fillers, which may be added to the curable pressure-sensitive adhesive to obtain a filled curable pressure-sensitive adhesive. These fillers are particulate fillers having an average particle diameter (D50) of 5 μm or more, preferably 10 μm or more, more preferably 20 μm or more, which are insoluble in the curable pressure-sensitive adhesive and present in the latter, correspondingly, as a dispersion, and also macroscopic fillers such as fibres, for example. The insoluble fillers are preferably selected from the group consisting of particulate fillers. More preferably, the insoluble fillers are selected from the group consisting of expandable hollow polymer beads, non-expandable hollow polymer beads, solid polymer beads, hollow glass beads, solid glass beads, hollow ceramic beads, solid ceramic beads and/or solid carbon beads. Also candidates for insoluble fillers, however, are—for example—fibres, laid scrims, platelets and rodlets of materials insoluble in the curable pressure-sensitive adhesive. As a result of their in some cases already macroscopic dimensions and of the lack of solubility, they have substantially no influence on the above-disclosed relationships in the compositional chemistry of the curable pressure-sensitive adhesive, being present instead in a heterogeneous mixture with the curable adhesive. Correspondingly, in the context of the present invention, these insoluble fillers are not counted as part of the curable pressure-sensitive adhesive and are therefore not considered when calculating mass fractions relative to the mass of the curable pressure-sensitive adhesive. In the context of the present invention, the addition of insoluble fillers to a curable pressure-sensitive adhesive of the invention is instead defined as resulting in a filled curable pressure-sensitive adhesive, i.e. a filled curable pressure-sensitive adhesive comprising:
i) a curable pressure-sensitive adhesive of the invention, preferably as disclosed above as being preferred, and
ii) one or more insoluble fillers.

With particular preference, the combined mass fraction of the insoluble fillers here is in the range from 0.1% to 50%, preferably in the range from 0.15% to 40%, more preferably in the range from 0.2% to 30%, based on the mass of the filled curable pressure-sensitive adhesive.

Curable pressure-sensitive adhesives of the invention may be used, for example, directly as pressure-sensitive adhesives, and according to application method may be provided in particular in the form of tapes. The invention therefore also relates to a pressure-sensitive adhesive tape, more particularly a reactive pressure-sensitive adhesive tape, comprising as adhesive layer a curable pressure-sensitive adhesive of the invention, with the adhesive tape preferably comprising a carrier layer.

With a view to the most favourable possible handling qualities, particularly advantageous results are generally achieved when curable pressure-sensitive adhesives of the invention are used as an adhesive layer in a single-sided or double-sided pressure-sensitive adhesive tape, when this tape either also comprises a carrier layer or the adhesive layer is arranged on a release layer, a liner for example, from which the adhesive layer is easily detachable.

The concept of adhesive tape is clear to the skilled person in the field of adhesive technology. In the context of the present invention, the expression “tape” refers to all thin, sheetlike structures, i.e. structures having a predominant extent in two dimensions, especially films, film portions and labels, preferably tapes with extended length and limited width, and also corresponding tape portions.

The carrier layer usually denotes that layer of a multilayer adhesive tape of this kind that critically determines the mechanical and physical properties of the adhesive tape, such as the tensile strength, stretchability, insulation capacity or resilience, for example. Customary materials for the carrier layer are, for example, woven fabrics, laid scrims and polymeric films, examples being PET films and polyolefin films. The carrier layer, however, may also itself be pressure-sensitively adhesive. In one preferred embodiment, the adhesive tape of the invention may be a double-sided adhesive tape whose carrier layer is provided on both sides with a curable pressure-sensitive adhesive of the invention.

The carrier layer may also have electrically insulating properties, and so the corresponding adhesive tape of the invention is electrically insulating and can be used for the electrical insulation of an article. For this purpose it is possible to use insulating carrier films having a volume resistivity of >10¹⁵ Ωcm, preferably >10¹⁶ Ωcm, more preferably >10¹⁷ Ωcm, determined according to DIN EN 62631-3-1 (VDE 0307-3-1): 2017-01. The adhesive tape of the invention may accordingly, in one preferred embodiment, be a double-sided adhesive tape whose insulating carrier film is provided on both sides with a curable adhesive of the invention. In another preferred variant, the adhesive tape of the invention is a single-sided adhesive tape whose electrically insulating carrier film is provided on one side with a curable adhesive of the invention. Such single-sided adhesive tapes are outstandingly suitable for enveloping battery cells in hybrid vehicles and all-electric vehicles.

The insulating carrier film preferably comprises one or more materials selected from the group consisting of polyimide, polybenzimidazole, polyamideimide, polyetherimide, polyacetal, polyphenylene sulfide, polyether ether ketone, polytetrafluoroethylene, nylon 6, ultra-high molecular weight polyethylene, polypropylene, vinyl chloride resin, polystyrene, polyethylene terephthalate, acrylonitrile-butadiene-styrene, polycarbonate, polyvinyl chloride, ethylene-vinyl acetate copolymer and polyester, more preferably from the group consisting of polypropylene, polyethylene terephthalate, polycarbonate and polyvinyl chloride, more preferably from the group consisting of polypropylene and polyethylene terephthalate.

As far as the thickness of the carrier is concerned, there are in principle no particular restrictions. The carrier preferably has a thickness in the range from 20 μm to 100 μm, more preferably in the range from 30 μm to 90 μm, more preferably in the range from 40 μm to 75 μm.

In adhesive tapes of the invention, the adhesive layers may be lined with a release covering, called a release liner, in order to enable trouble-free unwinding and to protect the pressure-sensitive adhesive from fouling. Such release liners customarily consist of a single-sidedly or double-sidedly siliconized polymeric film (e.g. PET or PP) or of a siliconized paper carrier.

The invention relates, moreover, to the use of a curable pressure-sensitive adhesive of the invention or of a pressure-sensitive adhesive tape of the invention for the bonding of two or more components by curing of the curable pressure-sensitive adhesive.

With a view to efficient curing, preference is given to a use according to the invention wherein the curing of the curable pressure-sensitive adhesive takes place with a minimum dose of 4000 mJ/cm² or more, preferably 5000 mJ/cm² or more, more preferably 6000 mJ/cm² or more.

As explained above, it is particularly preferred from a performance standpoint if the curing takes place by means of a typical UV-LED, this being possible with the curable pressure-sensitive adhesives of the invention, in spite of the in this case reduced activity of sensitizers, even at high levels of epoxy-modified nitrile rubbers, if the cationic photoinitiators are tailored to the emission characteristics of the UV-LED, especially if the above-defined mass ratios are set between the cationic photoinitiators and the epoxy-modified nitrile rubbers. Preferred accordingly is a use according to the invention wherein the curing of the curable pressure-sensitive adhesive takes place with a UV-LED, preferably with a UV-LED whose emission maximum lies at a wavelength in the range from 320 to 410 nm, more preferably in the range from 340 to 390 nm, especially preferably in the range from 360 to 370 nm, more particularly at 365 nm.

The invention and preferred embodiments of the invention are further explained and described below with reference to experiments.

A. Preparation of the curable pressure-sensitive adhesives:

Curable pressure-sensitive adhesives were obtained from the constituents collated in Table 1, by mixing of the components in customary manner (as laboratory drawdowns from a 60% butanone solution).

TABLE 1
Composition of the curable pressure-sensitive adhesives; all figures in parts by weight

| | C1 | C2 | C3 | C4 | I1 | I2 | I3 | I4 | I5 |
|---|---|---|---|---|---|---|---|---|---|
| Levamelt 700 | 33.80 | 33.10 | 33.80 | 33.80 | 32.20 | 34.40 | 33.90 | 34.3 | 34.3 |
| D.E.R. 331 | 33.80 | 33.10 | 16.90 | 28.90 | 32.19 | 17.10 | 17.20 | 17.1 | 17.1 |
| D.E.R. 662E | 16.90 | 16.60 | 16.90 | 16.90 | 16.10 | 17.10 | 17.20 | 17.1 | 17.1 |
| Polydis 3610 | — | 1.90 | — | — | 4.70 | 17.10 | 17.20 | — | — |
| Polydis 3604 | — | — | — | — | — | — | — | 17.1 | — |
| Polydis 3614 | — | — | — | — | — | — | — | — | 17.1 |
| Polycavit 3662 | — | — | 16.90 | 4.90 | — | — | — | — | — |
| Capa 3050 | 12.60 | 12.40 | 12.60 | 12.60 | 12.10 | 12.80 | 12.50 | 12.8 | 12.8 |
| Titanium dioxide | — | — | — | — | — | — | 0.30 | — | — |
| 1,4-Bis(mesitylamino)- | — | — | — | — | — | — | 0.20 | — | — |
| anthraquinone | | | | | | | | | |
| Omnirad BDK/ | 1.0 | 1.0 | 1.0 | 1.0 | 1.0 | — | — | — | — |
| Irgacure 651 | | | | | | | | | |
| Deuteron UV 1242 | 1.9 | 1.9 | 1.9 | 1.9 | 1.9 | — | — | | |
| Triarylsulfonium hexa- | — | — | — | — | — | 1.5 | — | 1.5 | 1.5 |
| fluorophosphate | | | | | | | | | |
| (50% in propylene | | | | | | | | | |
| carbonate) | | | | | | | | | |
| Tris(4-((4- | — | — | — | — | — | — | 1.5 | — | — |
| acetylphenyl)sulfanyl)- | | | | | | | | | |
| phenyl)sulfonium | | | | | | | | | |
| hexafluorophosphate | | | | | | | | | |

The (co)polymer used was the commercially available ethylene-vinyl acetate copolymer Levamelt 700 (vinyl acetate content of 70 percent by weight) from Arlanxeo.

Epoxide compounds used were a commercially available solid bisphenol-A diglycidyl ether (trade name D.E.R. 662E; weight-average molar mass M_{w}<2000 g/mol) and a commercially available liquid bisphenol-A diglycidyl ether (trade name D.E.R. 331; weight-average molar mass M_{w}<2000 g/mol) from Olin.

Epoxy-modified nitrile rubbers used were commercially available epoxy-modified nitrile rubbers (trade name Struktol Polydis 3610, 3604 and 3614) from Schill+Seilacher “Struktol” GmbH. The Polydis 3610 component exhibits a total of seven maxima in the GPC elugram, with the five middle maxima each being at least twice as large as the low-molecular maximum.

The epoxy-modified comparative polymer used was a commercially available epoxy-modified polyalkylene glycol (trade name Struktol Polycavit 3662) from Schill+Seilacher “Struktol” GmbH.

The polyol used was a commercially available polyester polyol based on polycaprolactone (trade name Capa 3050) from Ingevity.

The cationic initiator used was in certain cases bis(4,4′-dodecylphenyl)iodonium hexafluoroantimonate (CAS 71786-70-4; 50% solution in glycidyl ether (CAS 68609-97-2); the figures for the initial mass in Table 1 are based on the solution (trade name Deuteron UV 1242) from Deuteron in combination with 2,2-dimethoxy-1,2-diphenylethan-1-one (trade name Irgacure 651) from BASF or 2,2-dimethoxy-2-phenylacetophenone (CAS 24650-42-8; trade name Omnirad BDK) from IGM Resins.

The cationic initiator used was in some other cases triarylsulfonium hexafluorophosphate (50% in propylene carbonate; CAS: 109037-77-6; the figures for the initial mass in Table 1 are based on the solution) from Sigma Aldrich.

The cationic initiator used was in further cases tris(4-((4-acetylphenyl)sulfanyl)phenyl)sulfonium hexafluorophosphate (CAS: 953084-13-4) from IGM Resins.

The dye used was 1,4-bis(mesitylamino)anthraquinone (CAS: 116-75-6; trade name Solvaperm 2B-CN) from Clariant.

The curable adhesives produced were drawn down on a 50 μm PET film to produce adhesive tapes having a total thickness of about 100 μm.

B. Bonding experiments:

Peel adhesion:

The peel adhesion forces were determined in analogy to ISO 29862 (Method 3) at 23° C. and 50% relative humidity with a removal speed of 300 mm/min and a removal angle of 180° . The thickness of the layer of adhesive in each case was 100 μm. The reinforcing film used was an etched PET film having a thickness of 50 μm, as available from Coveme (Italy). The substrates used were steel plates in line with the standard. The bonding of the uncured measuring strip was performed by means of a roller application machine at 4 kg and a temperature of 23° C. The adhesive tapes were peeled off immediately after application. The measurements on the cured measuring strips took place analogously after curing with suitable light (Honle 365 nm LED lamp with a UV-A dose of 5000 mJ/cm²). The measured value (in N/cm) was obtained as the average value from three individual measurements, and the failure mode was recorded as follows: adhesive failure (A) or cohesive failure (C).

The results are shown in Table 2.

TABLE 2
Summary of the bonding experiments

| | C1 | C2 | C3 | C4 | I1 | I2 | I3 | I4 | I5 |
|---|---|---|---|---|---|---|---|---|---|
| Fracture mode*/Peel | A | A | A | A | A | A | A | A | A |
| adhesion (before curing)/ | >1 | >1 | >1 | >1 | >1 | >1 | >1 | >1 | >1 |
| (N/cm) | | | | | | | | | |
| Peel adhesion/ | 0.80 | 0.21 | 0.74 | 1.19 | 6.39 | 9.18 | 12.85 | 7.69 | 9.72 |
| Fracture mode* (after curing)/ | (A) | (A) | (A) | (A) | (A) | (A) | (A) | (A) | (A) |
| (N/cm) | | | | | | | | | |

*A: adhesive failure;
C: cohesive failure

On the basis of the bonding experiments, it is possible to confirm advantageous cohesion, pronounced pressure-sensitive adhesive properties and an excellent peel adhesion for samples 11 to 15.

Comparison of the measured values for the sample 11 with the comparative examples C1 and C2 not only shows the unexpected advantageous effect of adding an epoxy-modified nitrile rubber, but also illustrates that the positive effect on the peel adhesion shows an unexpectedly sharp rise between 1.9% and 4.7% mass fraction. It was completely surprising that the addition of an epoxy-modified nitrile rubber, which at low levels in fact impairs the technical adhesive properties, as would have been the probable expectation on the basis of the prior art discussed above, increases the peel adhesion so markedly beyond a certain minimum level.

The measured values for comparative examples C3 and C4, in comparison with the samples according to the invention, show that the positive effect of the epoxy-modified nitrile rubber is not reproducible with arbitrary, different epoxy-modified polymers, but that, instead, the epoxy-modified nitrile rubber has a particular importance in this regard.

The measured values for the inventive samples I2 to I5 illustrate the fact that for high levels of the epoxy-modified nitrile rubber, particularly advantageous technical adhesive properties are manifested, and excellent bonding strength is also achieved, in particular. Moreover, the comparison of the measured values for the samples I2 and I3 illustrates (since the titanium dioxide serves only to set a desired opacity) that the addition of a blue dye to the specific curable pressure-sensitive adhesives of the present invention has a positive effect on the peel adhesion.

C. Curing properties:

To investigate the influence of the epoxy-modified nitrile rubber on the curing properties, curable pressure-sensitive adhesives according to the stipulations in Table 3 were obtained from the constituents already described above in a customary way (as laboratory drawdowns from a 60% butanone solution).

TABLE 3
Composition of the curable pressure-sensitive adhesives;
all figures in parts by weight

| | I6 | I7 |
|---|---|---|
| Levamelt 700 | 33.80 | 34.80 |
| D.E.R. 331 | 0.00 | 33.80 |
| D.E.R. 662E | 16.90 | 0.00 |
| Polydis 3610 | 33.80 | 16.90 |
| Capa 3050 | 12.60 | 12.60 |
| Omnirad BDK/ | 1.0 | 1.0 |
| Irgacure 651 | | |
| Deuteron UV 1242 | 1.9 | 1.9 |

In contrast to the sample 11, the samples I6 and I7 can no longer be efficiently cured with the Honle 365 nm LED lamp. The curing of the samples I6 and I7 requires the use of electromagnetic radiation of the wavelength suitable for Deuteron UV 1242 in the region of about 220 to 250 nm. In order still to enable curing with the Honle 365 nm LED lamp, the initiator system may be switched alternatively to cationic photoinitiators having a higher activation wavelength, as used above, for example, for the samples I2 and I3.

1. Curable pressure-sensitive adhesive, comprising, based on the total mass of the curable pressure-sensitive adhesive:
a) one or more film-forming (co)polymers in a combined mass fraction in the range from 20% to 60%,
b) one or more polymerizable epoxide compounds in a combined mass fraction in the range from 20% to 60%, the epoxide compounds being selected from the group consisting of monomeric and oligomeric epoxide compounds,
c) one or more cationic photoinitiators in a combined mass fraction in the range from 0.5% to 10 7%, and
d) one or more epoxy-modified nitrile rubbers in a combined mass fraction in the range from 3% to 30%.

2. Curable pressure-sensitive adhesive according to claim 1, wherein the combined mass fraction of the (co)polymers in the curable pressure-sensitive adhesive is in the range from 20% to 55%, based on the mass of the curable pressure-sensitive adhesive.

3. Curable pressure-sensitive adhesive according to either of claim 1, wherein the combined mass fraction of the polymerizable epoxide compounds in the curable pressure-sensitive adhesive is in the range from 30% to 60%, based on the mass of the curable pressure-sensitive adhesive.

4. Curable pressure-sensitive adhesive according to claim 1, wherein the combined mass fraction of the epoxy-modified nitrile rubbers in the curable pressure-sensitive adhesive is in the range from 3.5% to 25%, based on the mass of the curable pressure-sensitive adhesive.

5. Curable pressure-sensitive adhesive according to claim 1, wherein the one or the two or more cationic photoinitiators are selected from the group consisting of cationic photoinitiators whose counterion is selected from the group consisting of hexafluorophosphate, hexafluoroantimonate and tetrakispentafluorophenylborate.

6. Curable pressure-sensitive adhesive according to claim 1, wherein the one or the two or more cationic photoinitiators have the highest-wavelength absorption maximum at a wavelength of 290 nm or more.

7. Curable pressure-sensitive adhesive according to claim 1, wherein the ratio of the combined mass fraction of the cationic photoinitiators divided by the combined mass fraction of the epoxy-modified nitrile rubbers is in the range from 0.06 to 0.6.

8. Curable pressure-sensitive adhesive according to claim 1, wherein the curable pressure-sensitive adhesive comprises one or more dyes.

9. Curable pressure-sensitive adhesive according to claim 8, wherein the one or the two or more dyes are selected from the group consisting of blue dyes.

10. Pressure-sensitive adhesive tape, comprising as adhesive layer a curable pressure-sensitive adhesive according to claim 1.

11. A method for bonding two or more components which comprises curing the curable pressure-sensitive adhesive according to claim 1.

12. A method for bonding two or more components which comprises curing the pressure-sensitive adhesive tape according to claim 10.

11. he method according to claim 11, wherein the curing of the curable pressure-sensitive adhesive takes place with a UV-LED.

14. The method according to claim 13, wherein the curing of the curable pressure-sensitive adhesive takes place with a minimum dose of 4000 mJ/cm² or more.
